(19) United States
(12) Patent Application Publication
(10) Pub. No.: US 2019/0236724 A1
(43) Pub. Date: Aug. 1, 2019

(54) CROP INDICATOR DETERMINATION USING MULTIPLE RAINFALL INDEX ANALYSIS

(71) Applicant: UNIVERSITY OF FLORIDA RESEARCH FOUNDATION INCORPORATED, Gainesville, FL (US)

(72) Inventors: Chitsomanus P. Muneepeerakul, Gainesville, FL (US); Rachata Muneepeerakul, Gainesville, FL (US)

(21) Appl. No.: 16/338,010

(22) PCT Filed: Sep. 29, 2017
(86) PCT No.: PCT/US2017/054335

§ 371 Date: Mar. 29, 2019

Related U.S. Application Data
(60) Provisional application No. 62/402,128, filed on Sep. 30, 2016.

(51) Int. Cl. G06Q 50/02; A01B 79/00; G06Q 10/04; G06Q 10/06

(52) U.S. Cl. CPC G06Q 50/02; G06Q 10/0639; G06Q 10/04; A01B 79/005

(57) ABSTRACT

A crop indicator corresponding to a predicted and/or present and/or previous state of a crop is determined. For example, measurement data related to the crop is received. At least a portion of the measurement data corresponds to rainfall at a location nearby the crop. The measurement data is analyzed to determine index data, wherein the index data comprises index data relating to two or more rainfall indices. A crop yield estimate is determined based on the index data and an appropriate crop yield model. A crop value estimate is determined based on the crop yield estimate. A crop indicator is determined based at least one of the crop value estimate or the crop yield estimate. In some embodiments, one or more elements of a financial instrument and/or crop planning and/or the like corresponding and/or related to the crop is determined based on the crop indicator.

### BACKGROUND

Weather index insurance promises financial resilience to farmers struck by harsh weather conditions with swift compensation at an affordable premium as well as minimal moral hazard. Despite these advantages, the very nature of indexing gives rise to basis risk as the selected weather index and corresponding thresholds do not sufficiently correspond to actual damages.

Thus, there is a need in the art for methods, apparatuses, systems, computing devices, and/or the like for providing better financial resiliency to farmers, for example, by reducing the basis risk of index insurance.

### BRIEF SUMMARY

In general, embodiments of the present invention provide methods, apparatus, systems, computing devices, computing entities, and/or the like for performing a multiple rainfall index analysis and/or determining a crop indicator. In an example embodiment, a crop indicator may be a crop quantity and/or yield estimate; crop value estimate; a probability that a crop will have a particular value at a particular point in time (e.g., at harvest); an indication of how well or how poorly a crop is predicted to perform, grow, and/or produce; and/or the like. For example, a crop indicator may be used to determine if a payout of a multiple rainfall index insurance policy covering a crop should be triggered or the probability that such a payoff may be triggered, in an example embodiment. For example, a crop indicator may indicate and/or correspond to a predicted and/or current and/or previous state of a crop. In an example embodiment, a crop indicator may be determined based on measurement information/data. For example, measurement information/data corresponding to rainfall at a location of the crop or nearby the crop may be used to determine index information/data. The index information/data may be used to generate and/or evaluate a crop yield model that may be used to determine a historical and/or current and/or predicted crop yield estimate. The crop yield estimate, predicted unit price for the crop, and/or the like may be used to determine a crop indicator corresponding to one or more states of the crop. The description herein describes determining and using a crop indicator for a crop; however, in various embodiments, a crop indicator may be determined and/or used that corresponds to multiple crops.

In an example embodiment, a crop indicator array comprising a plurality of crop indicators may be determined based on a plurality or range of likely and/or possible indices. In an example embodiment, a crop indicator array may be an array, table, matrix, and/or the like of crop indicators. Each crop indicator of the crop indicator array may correspond to a specific set of indices. For example, the crop indicator array may comprise a plurality of crop indicators, with each crop indicator corresponding to a particular scenario, wherein each scenario is defined by a set of indices. For example, a crop indicator array may be used as a “look up table” to determine a crop indicator for a particular choice or set of indices. For example, a crop indicator array may be generated before the planting and/or growing season for the crop. In various embodiments, a crop indicator array may be used to determine, calculate, and/or the like a premium for a multiple index insurance policy for insuring the corresponding crop. In various embodiments, a crop indicator array may be used to determine, calculate, and/or the like a payout for one or more scenarios (wherein each scenario is defined by a set of indices) for a multiple rainfall index insurance policy for insuring the corresponding crop. In an example embodiment, the crop indicator and/or a crop indicator array may be used to determine, calculate, decide, and/or the like the price and/or payout and/or structure of one or more financial derivative(s) corresponding to and/or relating to the crop. In an example embodiment, the crop indicator may be used to perform crop planning and/or the like.

In an example embodiment, the multiple rainfall index analysis used to determine the crop indicator is based on two or more indices. The two or more indices comprise at least two rainfall indices. In an example embodiment, the two or more indices may comprise one or more other weather indices (e.g., average temperature, average high temperature, average low temperature, average cloud cover, average energy flux of sunlight, average relative humidity, and/or the like), and/or other indices in addition to the at least two rainfall indices. Measurement information/data used to determine, calculate, and/or the like the indices may be captured, generated, measured, sensed, and/or the like by one or more sensors (e.g., rain gauges, radar systems, thermometers, energy flux meters, and/or the like). The one or more sensors may be located at the location of the crop and/or nearby the location of the crop (e.g., within the same geographic area such as within a few miles, in the same town, county, region, state, province, and/or the like). Various embodiments provide an automated determination of a crop indicator and/or a crop indicator array based on one or more crop yield models, measurement information/data (e.g., that is automatically collected), and/or the like. Thus, various embodiments provide an improvement to the field of determining a crop indicator that indicates and/or corresponds to a current and/or previous and/or predicted state of a crop and/or determining a crop indicator array that may be used to determine a crop indicator for a particular choice or set of indices.

According to a first aspect of the present invention, a method for determining a crop indicator corresponding to a state or states of a crop or multiple crops is provided. In an example embodiment, the method comprises receiving, by an analysis computing entity comprising at least one processor and a communications interface configured for communicating via at least one network, measurement data captured by one or more sensors at a location at least nearby the crop. At least one of the one or more sensors configured to capture measurement data corresponding to rainfall. The method further comprises analyzing, by the analysis computing entity, the measurement data to determine index data. The index data comprises index data relating to two or more rainfall indices. The method further comprises determining, by the analysis computing entity, a crop yield estimate based on the index data and an appropriate crop yield model; determining, by the analysis computing entity, a crop value estimate based on the crop yield estimate; and determining, by the analysis computing entity, the crop indicator based on the crop value estimate and/or crop yield estimate.

According to another aspect of the present invention, a method for determining a crop indicator corresponding to a state or states of a crop or multiple crops based on a crop indicator array is provided. In an example embodiment, the method comprises determining, by an analysis computing entity comprising at least one processor and a communications interface configured for communicating via at least one network, a crop yield estimate for each of a plurality of bins based on a multiple index crop yield model. Each bin is characterized by two or more indices, wherein the two or more indices comprise two or more rainfall indices. The method further comprises determining, by the analysis computing entity, a crop value estimate for at least one bin of the plurality of bins based on the crop yield estimate of the bin; and determining, by the analysis computing entity, a crop indicator array. The crop indicator array comprises a particular crop indicator for a particular bin of the plurality of bins determined based on the crop value estimate(s) and/or crop yield estimate(s) corresponding to the indices of the particular bin. The method further comprises receiving, by the analysis computing entity, measurement data related to the crop. The measurement data is/was captured by one or more sensors at a location at least nearby the crop. At least one of the one or more sensors configured to capture measurement data corresponding to rainfall. The method further comprises analyzing, by the analysis computing entity, the measurement data to determine index data; identifying, by the analysis computing entity, a particular bin of the plurality of bins based on the index data; and determining, by the analysis computing entity, the crop indicator based on the identified particular bin.

According to yet another aspect of the present invention, an apparatus for determining a crop indicator corresponding to a state of a crop or multiple crops is provided. In an example embodiment, the apparatus comprises at least one processor, a communications interface configured for communicating via at least one network, and at least one memory storing computer program code. The at least one memory and the computer program code are configured to, with the processor, cause the apparatus to at least receive measurement data related to the crop. The measurement data is/was captured by one or more sensors at a location at least nearby the crop. At least one of the one or more sensors is configured to capture measurement data corresponding to rainfall. The at least one memory and the computer program code are further configured to, with the processor, cause the apparatus to at least analyze the measurement data to determine index data, wherein the index data comprises index data relating to two or more rainfall indices; determine a crop yield estimate based on the index data and an appropriate crop yield model; determine a crop value estimate based on the crop yield estimate; and determine the crop indicator based on the crop value estimate and/or crop yield estimate.

According to still another aspect of the present invention a computer program product for determining a crop indicator corresponding to a state of a crop or multiple crops is provided. In an example embodiment, the computer program product comprises at least one non-transitory computer-readable storage medium having computer-executable program code instructions stored therein. The computer-executable program code instructions comprise program code instructions configured to receive measurement data related to the crop. The measurement data is captured by one or more sensors at a location at least nearby the crop. At least one of the one or more sensors is configured to capture measurement data corresponding to rainfall. The computer-executable program code instructions further comprise program code instructions configured to analyze the measurement data to determine index data, wherein the index data comprises index data relating to two or more rainfall indices; determine a crop yield estimate based on the index data and an appropriate crop yield model; determine a crop value estimate based on the crop yield estimate; and determine the crop indicator based on the crop value estimate and/or crop yield estimate.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system that can be used to practice embodiments of the present invention.

FIG. 2 is an exemplary schematic diagram of an analysis computing entity according to one embodiment of the present invention.

FIG. 3 is an exemplary schematic diagram of a user computing entity according to one embodiment of the present invention.

FIG. 4 provides a flowchart illustrating operations and processes that can be used in accordance with various embodiments of the present invention.

FIG. 5 is a plot showing the determination of crop yield estimate according to an embodiment of the present invention compared to a determination of crop yield estimate using traditional methods.

FIG. 6 provides a flowchart illustrating operations and processes that can be used in accordance with various embodiments of the present invention.

FIG. 7 is an exemplary layout of a two index look-up table, in accordance with various embodiments of the present invention.

### DETAILED DESCRIPTION OF VARIOUS EXAMPLE EMBODIMENTS

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. COMPUTER PROGRAM PRODUCTS, METHODS, AND COMPUTING ENTITIES

Embodiments of the present invention may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. EXEMPLARY SYSTEM ARCHITECTURE

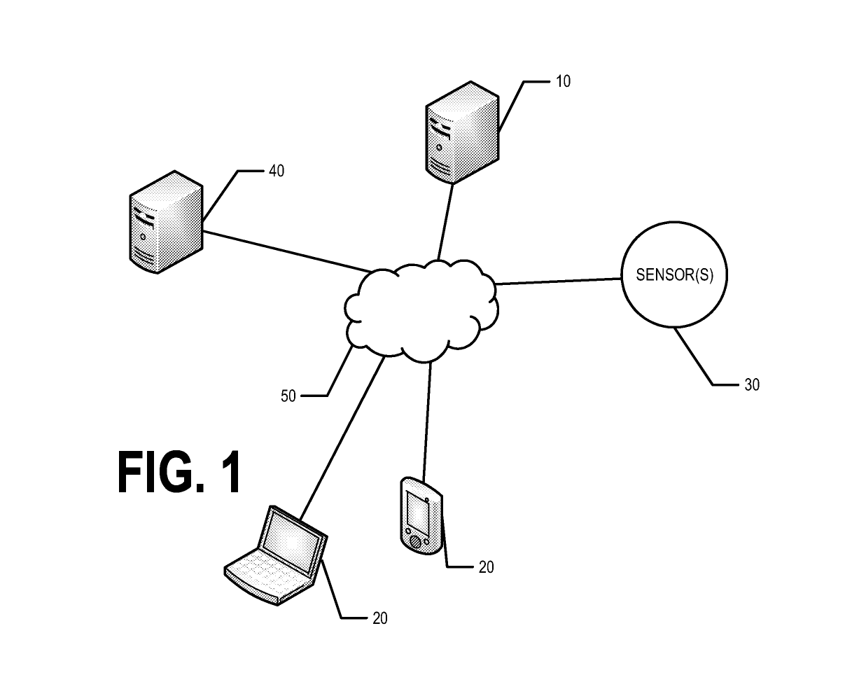

FIG. 1 provides an illustration of an exemplary embodiment of the present invention. As shown in FIG. 1, this particular embodiment may include one or more analysis computing entities 10, one or more user computing entities 20, one or more sensors 30, one or more index information/data computing entities 40, one or more networks 50, and/or the like. Each of these components, entities, devices, systems, and similar words used herein interchangeably may be in direct or indirect communication with, for example, one another over the same or different wired or wireless networks. Additionally, while FIG. 1 illustrates the various system entities as separate, standalone entities, the various embodiments are not limited to this particular architecture.

### 1. Exemplary Analysis Computing Entity

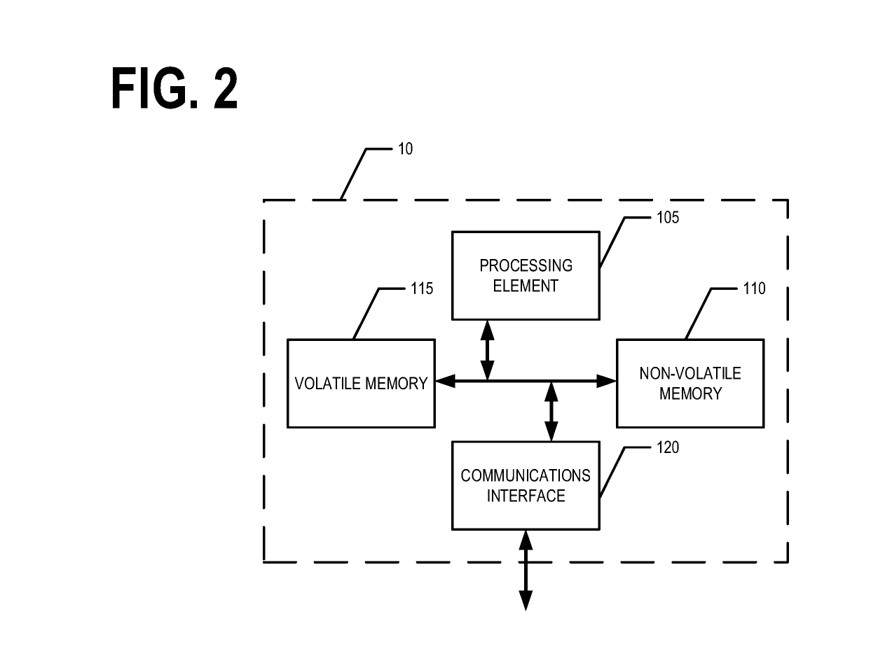

FIG. 2 provides a schematic of an analysis computing entity 10 according to one embodiment of the present invention. In example embodiments, an analysis computing entity 10 may be operated by and/or behalf of a government or non-governmental organization or agency, an insurance provider, financial analyst, and/or the like. In example embodiments, the analysis computing entity 10 may be configured to determine, calculate, compute, estimate, and/or the like an crop yield estimate, an crop value estimate, a premium for insuring a crop, a payout or settlement for damage to a crop, and/or the like based on at least two indices. In example embodiments, the analysis computing entity 10 may be configured to analyze measurement information/data and/or index information/data to determine, compute, and/or the like two or more indices. In example embodiments, the analysis computing entity 10 may be configured to determine a look-up table for determining a premium for insuring a crop or a payout/settlement for damage to a crop that is determined by two or more indices.

In general, the terms computing entity, computer, entity, device, system, and/or similar words used herein interchangeably may refer to, for example, one or more computers, computing entities, desktops, mobile phones, tablets, phablets, notebooks, laptops, distributed systems, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

In one embodiment, the analysis computing entity 10 may also include one or more communications interfaces 120 for communicating with various computing entities, such as by communicating data, content, information, and/or similar terms used herein interchangeably that can be transmitted, received, operated on, processed, displayed, stored, and/or the like.

As shown in FIG. 2, in one embodiment, the analysis computing entity 10 may include or be in communication with one or more processing elements 105 (also referred to as processors, processing circuitry, and/or similar terms used herein interchangeably) that communicate with other elements within the analysis computing entity 10 via a bus, for example. As will be understood, the processing element 105 may be embodied in a number of different ways. For example, the processing element 105 may be embodied as one or more complex programmable logic devices (CPLDs), microprocessors, multi-core processors, co-processing entities, application-specific instruction-set processors (ASIPs), microcontrollers, and/or controllers. Further, the processing element 105 may be embodied as one or more other processing devices or circuitry. The term circuitry may refer to an entirely hardware embodiment or a combination of hardware and computer program products. Thus, the processing element 105 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 105 may be configured for a particular use or configured to execute instructions stored in volatile or non-volatile media or otherwise accessible to the processing element 105. As such, whether configured by hardware or computer program products, or by a combination thereof, the processing element 105 may be capable of performing steps or operations according to embodiments of the present invention when configured accordingly.

In one embodiment, the analysis computing entity 10 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 110, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the analysis computing entity 10 may further include or be in communication with volatile media (also referred to as volatile storage, memory, memory storage, memory circuitry and/or similar terms used herein interchangeably). In one embodiment, the volatile storage or memory may also include one or more volatile storage or memory media 115, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 105. Thus, the databases, database instances, database management systems, data, applications, programs, program modules, scripts, source code, object code, byte code, compiled code, interpreted code, machine code, executable instructions, and/or the like may be used to control certain aspects of the operation of the analysis computing entity 10 with the assistance of the processing element 105 and operating system.

As indicated, in one embodiment, the analysis computing entity 10 may also include one or more communications interfaces 120 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the analysis computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the analysis computing entity 10 may include or be in communication with one or more input elements, such as a keyboard input, a mouse input, a touch screen/display input, motion input, movement input, audio input, pointing device input, joystick input, keypad input, and/or the like. The analysis computing entity 10 may also include or be in communication with one or more output elements (not shown), such as audio output, video output, screen/display output, motion output, movement output, a printer for providing printed output, and/or the like.

As will be appreciated, one or more of the analysis computing entity's 10 components may be located remotely from other analysis computing entity 10 components, such as in a distributed system. Furthermore, one or more of the components may be combined and additional components performing functions described herein may be included in the analysis computing entity 10. Thus, the analysis computing entity 10 can be adapted to accommodate a variety of needs and circumstances. As will be recognized, these architectures and descriptions are provided for exemplary purposes only and are not limiting to the various embodiments.

### 2. Exemplary User Computing Entity

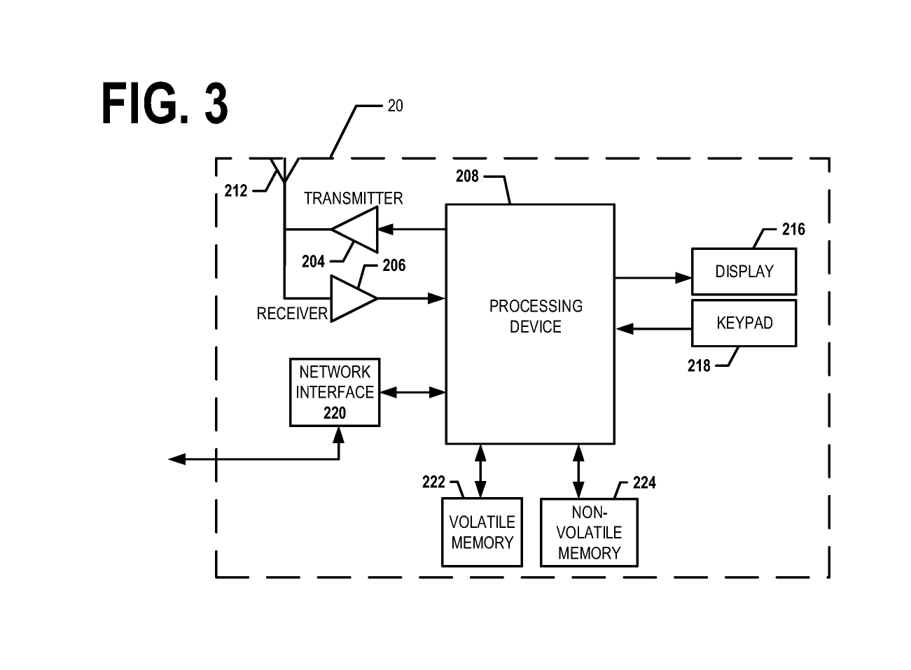

A user may be an individual, a family, a company, an organization, an entity, a department within an organization, a representative of an organization and/or person, and/or the like. For example, a user may be a farmer, representative of a farm, an officer of government or non-governmental organization or agency, and/or the like. A user may operate a user computing entity 20 that includes one or more components that are functionally similar to those of the analysis computing entity 10. FIG. 3 provides an illustrative schematic representative of a user computing entity 20 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, RFID tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. As shown in FIG. 3, the user computing entity 20 can include an antenna 212, a transmitter 204 (e.g., radio), a receiver 206 (e.g., radio), and a processing element 208 (e.g., CPLDs, microprocessors, multi-core processors, co-processing entities, ASIPs, microcontrollers, and/or controllers) that provides signals to and receives signals from the transmitter 204 and receiver 206, respectively.

The signals provided to and received from the transmitter 204 and the receiver 206, respectively, may include signaling information/data in accordance with air interface standards of applicable wireless systems. In this regard, the user computing entity 20 may be capable of operating with one or more air interface standards, communication protocols, modulation types, and access types. More particularly, the user computing entity 20 may operate in accordance with any of a number of wireless communication standards and protocols, such as those described above with regard to the analysis computing entity 10. In a particular embodiment, the user computing entity 20 may operate in accordance with multiple wireless communication standards and protocols, such as UMTS, CDMA2000, 1×RTT, WCDMA, GSM<EDGE, TD-SCDMA, LTE, E-UTRAN, EVDO, HSPA, HSDPA, Wi-Fi, Wi-Fi Direct, WiMAX, UWB, IR, NFC, Bluetooth, USB, Bluetooth low energy, ZigBee, near field communication, infrared, ultra-wideband, and/or the like. Similarly, the user computing entity 20 may operate in accordance with multiple wired communication standards and protocols, such as those described above with regard to the analysis computing entity 10 via a network interface 220.

Via these communication standards and protocols, the user computing entity 20 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The user computing entity 20 can also download changes, add-ons, and updates, for instance, to its firmware, software (e.g., including executable instructions, applications, program modules), and operating system.

According to one embodiment, the user computing entity 20 may include location determining aspects, devices, modules, functionalities, and/or similar words used herein interchangeably. For example, the user computing entity 20 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the user computing entity's 20 position in connection with a variety of other systems, including wireless towers, Wi-Fi access points, and/or the like. Similarly, the user computing entity 20 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, wireless towers, nearby computing devices (e.g., smartphones, laptops) and/or the like. For instance, such technologies may include the iBeacons, Gimbal proximity beacons, Bluetooth Low Energy (BLE) transmitters, NFC transmitters, infrared transmitters, ZigBee transmitters, ultra-wideband transmitters, and/or the like. These indoor positioning aspects can be used in a variety of settings to determine the location of someone or something to within inches or centimeters.

The user computing entity 20 may also comprise a user interface (that can include a display 216 coupled to a processing element 208) and/or a user input interface (coupled to a processing element 208). For example, the user interface may be a user application, browser, user interface, and/or similar words used herein interchangeably executing on and/or accessible via the user computing entity 20 to interact with and/or cause display of information/data from the analysis computing entity 10, as described herein. The user input interface can comprise any of a number of devices or interfaces allowing the user computing entity 20 to receive data, such as a keypad 218 (hard or soft), a touch display, voice/speech or motion interfaces, or other input device. In embodiments including a keypad 218, the keypad 218 can include (or cause display of) the conventional numeric (0-9) and related keys (#, *), and other keys used for operating the user computing entity 20 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The user computing entity 20 can also include volatile storage or memory 222 and/or non-volatile storage or memory 224, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the user computing entity 20. As indicated, this may include a user application that is resident on the entity or accessible through a browser or other user interface for communicating with the analysis computing entity 10 and/or various other computing entities.

In another embodiment, the user computing entity 20 may include one or more components or functionality that are the same or similar to those of the analysis computing entity 10, as described in greater detail above. As will be recognized, these architectures and descriptions are provided for exemplary purposes only and are not limiting to the various embodiments.

### 3. Exemplary Sensor

In various embodiments, one or more sensors 30 may be configured to measure and/or collect measurement information/data that may be used to determine index information/data. In example embodiments, the one or more sensors 30 may be configured to measure and/or collect measurement information/data relating to weather and/or environmental conditions. For example, in one embodiment, the one or more sensors 30 may comprise one or more rain gauges, thermometers, light meters, rain gauges, barometers, hygrometers, soil moisture content meters, instruments for measuring wind speed and/or direction, instruments for measuring rainfall intensity, radar systems, and/or the like. In one embodiment, the one or more sensors 30 may be configured to provide information regarding the intensity and frequency of rainfall at a particular location.

In example embodiments, the measurement information/data measured and/or collected by the one or more sensors 30 may be associated with a sensor location corresponding to the location where the measurement information/data was measured and/or collected. For example embodiments, the one or more sensors 30 may be in communication with and/or comprise a GPS sensor and/or other location determining aspects, devices, modules, functionalities, and/or similar words used herein interchangeably, as described above. The one or more sensors 30 may be configured to provide the location of the one or more sensors 30, as determined by the GPS sensor and/or other location determining aspect, when the one or more sensors 30 provide the measurement information/data. In example embodiments, the one or more sensors 30 may be stationary and may be configured to provide a known location when the measurement information/data is provided without the use of a GPS sensor and/or other location determining aspect. In some embodiments, the one or more sensors 30 may provide a sensor identifier configured to uniquely identify the sensor when the one or more sensors 30 provide the measurement information/data. The sensor identifier may then be used to determine a known location of the sensor identified thereby. In another embodiment, the one or more sensors 30 may provide the measurement information/data via a display and/or the like such that a user may enter the measurement information/data through a user interface of the user computing entity 20. The user interface may comprise a field for the user to provide information/data identifying the location of the one or more sensors 30 which measured and/or collected the measurement information/data being entered and/or the user computing entity 20 access the location determining aspect of the user computing entity 20 to determine a current physical location of the user computing entity 20 and tag the measurement information/data with the current physical location of the user computing entity 20.

As indicated above, the one or more sensors 30 may be configured to provide measurement information/data. For example, the one or more sensors may be configured to provide measurement information/data to an analysis computing entity 10, a user computing entity 20, an index information/data computing entity 40, and/or the like. In another example, the one or more sensors 30 may be configured to provide a visual and/or audio indication (e.g., via a display device, speakers, and/or the like) of the measurement information/data and a user may enter the measurement information/data into an interface of, for example, the user computing entity 20. In example embodiments, the one or more sensors 30 may be configured to provide the measurement information/data through one or more wired or wireless networks 50. For example, such communication may be executed using a wired data transmission protocol, such as FDDI, DSL, Ethernet, ATM, frame relay, DOCSIS, or any other wired transmission protocol. Similarly, at least one of the one or more sensors 30 may be configured to communicate via wireless external communication networks using any of a variety of protocols, such as GPRS, UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR protocols, NFC protocols, Wibree, Bluetooth protocols, wireless USB protocols, and/or any other wireless protocol.

In example embodiments, the one or more sensors may be configured to measure and/or collect measurement information/data routinely, periodically, in response to one or more triggers, and/or the like. For example, the one or more sensors may be configured to measure and/or collect measurement information/data every fifteen minutes, every hour, every few hours, once a day, cumulatively throughout the day, and/or the like. In example embodiments, the one or more sensors 30 may be configured to provide the measurement information/data daily. However, the measurement information/data may be provided more frequently (e.g., every few hours) or less frequently (e.g., once a week), as appropriate for the application, data transmission requirements, amount of information/data to be transmitted, and/or the like.

In example embodiments, the one or more sensors 30 may be in communication with, operated by, and/or the like a sensor control unit. The sensor control unit may comprise a processor, memory, communication interface, user interface, and/or the like as described above with respect to the analysis computing entity 10 and/or the user computing entity 20. For example, the sensor control unit may be configured to cause at least one of the one or more sensors 30 to measure and/or collect measurement information/data; operate, communicate with, and/or comprise a location determining aspect; store measured and/or collected measurement information/data; cause display of measurement information/data; provide measurement information/data; and/or the like. In one embodiment, at least one sensor 30 is not in communication with, operated by, and/or the like a sensor control unit. For example, in one embodiment, the one or more sensors 30 comprises a rain gauge that consists of a rain receptacle for collecting rain and a scale that a user may use to determine how much rain was collected in the rain receptacle. The user may then enter the determined amount of rain into a user interface provided by the user computing entity 20.

### 4. Exemplary Index Information/Data Computing Entity

In various embodiments, the index information/data computing entity 40 may be configured to receive, store, and/or provide measurement information/data, information/data linking a sensor 30 to a corresponding location of the sensor 30 (e.g., based on the sensor identifier), index information/data, and/or other information/data that may be requested by any of a variety of computing entities. For example, the index information/data computing entity 40 may be configured to determine, compute and/or the like one or more crop models based on one or more indices; receive, store, determine, and/or provide one or more crop futures and/or crop value estimates, and/or the like. In example embodiments, the index information/data computing entity 40 may be operated by and/or on behalf of a government or non-governmental organization or agency, financial institution, insurance company, and/or the like.

In one embodiment, an index information/data computing entity 40 may include one or more components that are functionally similar to those of the analysis computing entity 10, user computing entity 20, and/or the like. For example, in one embodiment, each index information/data computing entity 40 may include one or more processing elements (e.g., CPLDs, microprocessors, multi-core processors, co-processing entities, ASIPs, microcontrollers, and/or controllers), one or more display device/input devices (e.g., including user interfaces), volatile and non-volatile storage or memory, and/or one or more communications interfaces. For example, the user interface may be a user application, browser, user interface, and/or similar words used herein interchangeably executing on and/or accessible via the index information/data computing entity 40 to interact with and/or cause display of information/data from various other entities.

### III. EXEMPLARY SYSTEM OPERATION

Example embodiments of the present invention provide a multiple rainfall index analysis for determining a crop yield or quantity estimate and/or crop value estimate. The crop yield or quantity estimate and/or value may be used to determine a premium and/or payout value for an index insurance policy and/or a financial derivative based on the multiple indices using the multiple rainfall index analysis. In example embodiments, the indices used for the multiple rainfall index analysis may comprise two or more indices related to rainfall. In example embodiments, the indices used for the multiple rainfall index analysis may comprise one or more additional weather and/or environmental indices that are determined based on measurement information/data measured and/or collected by one or more sensors 30, in addition to the two or more indices related to rainfall. For example, in one embodiment, the indices used for the multiple rainfall index analysis are average daily rainfall during a period of time (e.g., during the growing season and/or the like) and number of days during which rain was received during the period of time. In another embodiment, the indices used for the multiple rainfall index analysis are the average amount of rain during days on which rain was experienced during a period of time and the number of days during which rain was experienced during the period of time. The index information/data used in the analysis may be determined based on measurement information/data measured and/or collected by one or more rain gauges, radar systems, and/or other sensors 30.

As used herein, a crop may be a produce crop (e.g., any cultivated plant, fungus, or alga that is harvested for food, clothing, livestock fodder, biofuel, medicine, or other uses, including but not limited to wheat, corn, potatoes, soybeans, sugarcane, etc.), livestock, timber (e.g., for lumber or pulp), a mineral crop (e.g., produced through mining), environmental performance (e.g., pollutants and/or greenhouse gas emissions such as, for example, COₓ and/or NOₓ, soil erosion, nutrient leaching, salinity control), and/or other crops. In example embodiments, the multiple rainfall index analysis may be based on a location at which the crop is to be produced, which may be located at the same location and/or in the same geographic area (e.g., within a few miles, in the same town, county, region, state, province, and/or the like) as the one or more sensors 30. For example the one or more sensors 30 may capture measurement information/data for the location at which the crop is to be produced and/or nearby the location at which the crop is to be produced (e.g., within a few miles, in the same town, county, region, state, province, and/or the like). In general, the term nearby the location at which the crop is to be produced is used to indicate a location within a distance threshold of the location at which the crop is to be produced and a location for which the measurement information/data can be used to reasonably estimate the measurement information/data at the location at which the crop is to be produced.

Example embodiments of the present invention provide a multiple rainfall index analysis for determining a crop indicator. In an example embodiment, a crop indicator may be a crop value estimate; a probability that a crop will have a particular value at a particular point in time (e.g., at harvest); an indication of how well or how poorly a crop is predicted to perform, grow, and/or produce and/or the like; is performing, growing, producing and/or the like; and/or has performed, grown, produced and/or the like. For example, a crop indicator may be used to determine if a payout of a multiple rainfall insurance policy covering a crop has been triggered or the probability that such a payoff may be triggered, in an example embodiment. For example, a crop indicator may indicate and/or correspond to a predicted and/or current and/or previous state of a crop. In various embodiments, the multiple rainfall index analysis may be used for determining a crop indicator array. In an example embodiment, a crop indicator array comprises a plurality of crop indicators based on a plurality or range of likely and/or possible indices. In an example embodiment, a crop indicator array may be an array, table, matrix, and/or the like of crop indicators. Each crop indicator of the crop indicator array may correspond to a specific set of indices. For example, the crop indicator array may comprise a plurality of crop indicators, with each crop indicator corresponding to a particular scenario, wherein each scenario is defined by a set of indices. For example, a crop indicator array may be used as a “look up table” to determine a crop indicator for a particular choice or set of indices.

In example embodiments, a user (e.g., operating a user computing entity 20) may submit a request for a quote for a multiple rainfall index insurance policy to insure a crop. In example embodiments, a multiple rainfall index insurance policy is an index insurance policy wherein the premium and payout are determined using two or more rainfall indices. In another example embodiment, a user (e.g., operating a user computing entity 20) may submit a request for a quote for a multiple rainfall index financial derivative. In example embodiments, the premium and payout of the multiple rainfall index insurance policy or financial derivative may be determined based on one or more additional indices (e.g., temperature and/or other weather indices and/or other crop health indices). The request may comprise various information/data relating to the crop. For example, the request may comprise the type of crop; acreage planted with the crop; particular crop strain, cultivar, and/or the like; drought and/or pest resistance information/data for the crop; location of the crop; soil information relating to the location of the crop; and/or other crop information/data. In one embodiment, the request may be received by an analysis computing entity 10. The analysis computing entity 10 may then request and receive and/or access measurement information/data and/or index information/data related and/or relevant to the crop, as determined based on the crop information/data received in the request. In example embodiments, for measurement information/data to be related and/or relevant to a crop, the measurement information/data may be measured and/or collected by one or more sensors 30 located at the same location and/or in the same geographic area (e.g., within a few miles, in the same town, county, region, state, province, and/or the like). Related and/or relevant index information/data may be determined based on related and/or relevant measurement information/data and/or identified based at least in part on received crop information/data. The measurement information/data and/or index information/data may then be used to perform a multiple rainfall index analysis to determine a premium and/or payout value for one or more multiple rainfall index insurance policies for insuring the crop. In an example embodiment, the measurement information/data and/or index information/data may then be used to perform a multiple rainfall index analysis to determine a financial derivative related to the crop. One or more quote premium and/or payout values may then be provided to the user (e.g., operating the user computing entity 20).

It should be understood that the multiple rainfall index analysis may be used in a variety of ways to provide individuals or organizations with various options. As noted above, in some embodiments, the multiple rainfall index analysis may be used to inform premium and/or payout values and/or structure of one or more multiple rainfall index insurance policies for insuring a crop and/or of a financial derivative related to a crop. In example embodiments, such a multiple rainfall index insurance policy may be used as and/or in place of at least a portion of the collateral for loan. In another example embodiment, an individual and/or organization may purchase a first insurance policy based on a first rainfall index (e.g., total rainfall during a period of time) and a second insurance policy based on a second rainfall index (e.g., frequency of rainfall during a period of time). For example, the premium, payout, and/or structure and/or other details of the first insurance policy may be determined based on the risks and/or coverage based on the basis of the first rainfall index and the second insurance policy may be based on risks and/or coverage based on the second rainfall index. The first and second insurance policies may be bundled together to provide the individual or organization with a multiple rainfall index insurance policy. Various aspects of the present invention will now be described using the multiple rainfall index insurance policy example. However, it should be understood that the multiple rainfall index analysis provided herein may be applied to various contexts.

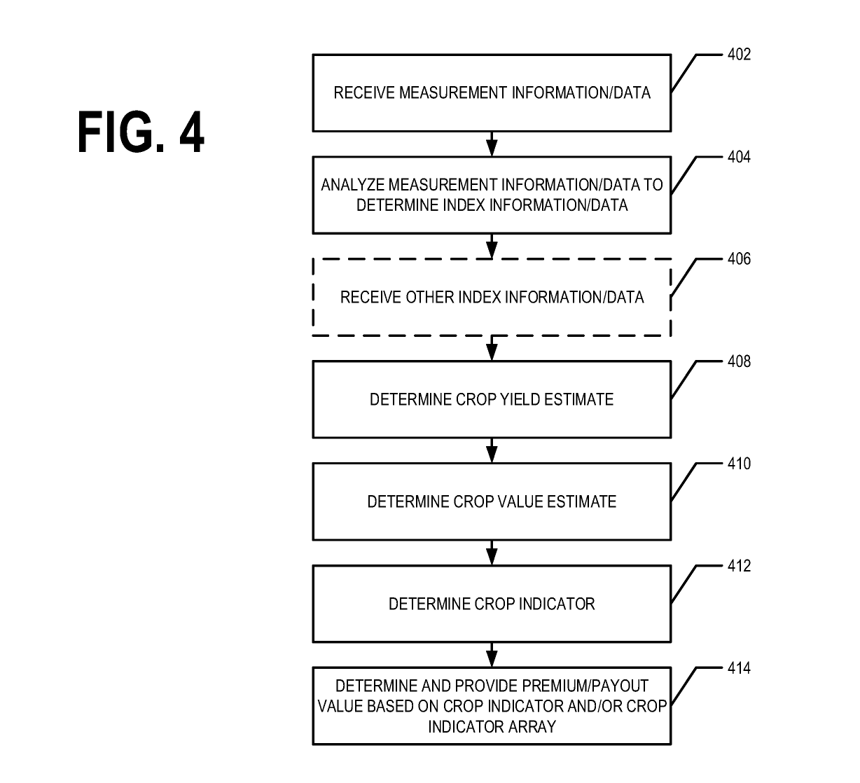

FIG. 4 provides a flowchart illustrating processes and procedures that may be performed in an example embodiment to perform a multiple rainfall index analysis to provide a premium and/or payout value for one or more multiple rainfall index insurance policies for insuring a crop. Starting at block 402, measurement information/data is received. In example embodiments, the measurement information/data may be related and/or relevant to a crop to be insured by a multiple rainfall index insurance policy. For example, the one or more sensors 30 may capture measurement information/data. The one or more sensors 30 may then provide the measurement information/data to one or more analysis computing entities 10, user computing entities 20, and/or index information/data computing entities 40. In another example, the measurement information/data may be displayed to a user by a display in communication with the one or more sensors 30 such that a user may enter the measurement information/data through a user interface of a user computing entity 20. In example embodiments, the measurement information/data may be associated with a sensor location corresponding to the location of the sensor(s) 30 that measured and/or collected the measurement information/data and/or sensor identifier configured to uniquely identify the sensor(s) 30 that measured and/or collected the measurement information/data. In example embodiments, the sensor identifier may be configured such that the sensor location may be determined based on the sensor identifier (e.g., based on a database entry indexed by the sensor identifier and comprising the sensor location, and/or the like). An analysis computing entity 10 may then receive the measurement information/data. For example, the one or more sensors 30, index information/data computing entity 40, and/or user computing entity 20 may provide (e.g., transmit) the measurement information/data such that the analysis computing entity 10 receives the measurement information/data. The measurement information/data received may depend, at least in part, on the crop being considered, the location of the crop, and/or the like.

At block 404 the measurement information/data may be analyzed to determine index information/data. For example, the analysis computing entity 10 may analyze the measurement information/data to determine index information/data. For example, the measurement information/data may comprise a rainfall amount recorded every day over a period of time. The desired index information/data may comprise the average amount of rainfall per day and the number of days during which rain was received. Therefore, the daily rainfall amount recorded every day over the period of time may be analyzed to determine the average daily rainfall and the number of days during which rain was received for the time period. In example embodiments, the analysis required to determine the index information/data based on the measurement information/data will depend on the available measurement information/data and the desired index information/data, as should be appreciated by one of skill in the art. In example embodiments, the index information/data that is determined is based on the crop, the location of the crop, and/or the like. In example embodiments, the index information/data comprises two or more indices related to rainfall.

At block 406, other index information/data may be received. For example, the analysis computing entity 10 may receive additional index information/data. For example, the index information/data computing entity 40 may provide (e.g., transmit) additional index information/data. In example embodiments, the additional index information/data may correspond to one or more indices that are not based on measurement information/data. For example, the additional index information/data may correspond to model information/data corresponding to the crop, value estimate information/data corresponding to the crop, and/or additional information/data related to the crop and/or the location of the crop.

At block 408, a yield estimate for the crop may be determined. For example, the analysis computing entity 10 may determine a crop yield or quantity estimate. For example, a crop yield model may be evaluated based on the determined and/or other index information/data. In example embodiments, the crop yield model may be a stochastic crop yield model having two or more rainfall parameters or indices. In example embodiments, the crop yield model evaluated may be based, selected, optimized, and/or the like at least in part on the crop information/data. Thus, the evaluated crop yield model may be appropriate for the crop for which the multiple rainfall index insurance is to insure. For example, a crop yield model may be evaluated based on average amount of rainfall per day and the number of days during which rain was received during a particular portion of the crop preparation, growing, season, vegetative period, reproductive period, and/or the like. The crop yield model may be evaluated based at least in part on the index information/data to determine a crop yield or quantity estimate. In example embodiments, the crop yield model may be based and/or evaluated based on a location of the crop. In example embodiments, the crop yield model may include one or more factors configured to account for heterogeneities between various crop locations, crop production practices, geographical differences between the crop location and the location where the measurement information/data was captured, and/or the like.

In example embodiments, the crop yield model may provide a probability distribution of the crop yield from which a crop yield estimate may be determined. The crop yield estimate may comprise an expected crop yield, crop yield at a specified quantile and/or residual risk, and/or a value at risk, and/or based on other risk measures.

Many different crop yield models may be used depending on the type of crop, other crop information/data, indices to be considered, and/or the like. The following example crop yield models are provided herein as illustrative examples. For example, the indices may be average daily rainfall and number of days during which rainfall occurred during a time period. These indices may be used to estimate the soil moisture during the growing season, vegetative period, reproductive period, and/or the like for the crop. The soil moisture influences crop production through its control on carbon assimilation and nutrient availability. For example, a rainfall intensity and frequency driven yield model may be defined as

$$\frac{dY ( t )}{dt} = {g}_{Y} ( s ) = \{ \begin{matrix}0 , & s < {s}_{w} \\ {{g}_{Y , max} [ \frac{s - {s}_{w}}{{s}^{*} - {s}_{w}} ]}^{a} , & {s}_{w} \leq s \leq {s}^{*} \\ {g}_{Y , max} , & s > {s}^{*}\end{matrix} ,$$

wherein Y(t) is the crop yield at time t, g_{Y}(s) is the soil moisture-dependent grain-filling rate, and a represents the sensitivity of crop yield to drought, s* is the soil moisture level at which incipient stomatal level occurs, and s_{w} is the soil moisture level at which the stomata are fully closed. As should be understood, g_{Y,max}, s*, s_{w}, and a may be selected, derived, optimized, and/or the like based on the crop type, other crop information/data, location, other measurement information/data (e.g., soil type, average daily temperature, other weather information/data), and/or the like. This model may then be used to determine the mean yield for the crop μ_{Y}= [symbol] g_{Y} [symbol] T_{Y} where T_{Y} is the period of grain filling from mobilization of carbon assimilates accumulated during the vegetative period and those synthesized during the last part of the growing season. By applying a probability density function of soil moisture, one can derive [symbol] g_{Y} [symbol] =g_{Y,max} [P′(s*)+Z(p(s),a)], wherein P′(s*) is the non-stressed proportion of time (e.g., the time when s>s*) during which crops achieve the maximum grain filling rate of g_{Y,max} and Z is the stress function that captures the non-linear response of the grain filling rate to soil moisture deficit (e.g., when s_{w}≤s≤s*), which is a function of the probability density function of the soil moisturep(s) and the drought sensitivity of the crop a. Additional details regarding this example crop yield model may be found in described in more detail in Appendix B of the corresponding provisional application (U.S. Appl. No. 62/402,128, filed Sep. 30, 2016). Thus, based on the index information/data, the crop yield model may be evaluated. In example embodiments, various crop yield models may be evaluated to determine a crop yield estimate, as appropriate for the application and the crop.

A modified numerical simulation is another example of a crop yield model that may be used to determine a crop yield distribution from two or more indices. For example, the two or more indices may comprise the specified total rainfall amount and the number of rainy days during a period of time (e.g., the growing season, and/or the like). In an example embodiment, the modified numerical simulation is determined based on the two or more indices while sufficiently maintaining various features of the stochastic yield model described in more detail in Appendix B of the corresponding provisional application (U.S. Appl. No. 62/402,128, filed Sep. 30, 2016). For example, the modified numerical simulation may be used to determine a crop yield and/or quantity and/or value estimate for a specified risk level using a specified risk measure for a specified rainfall (TR) and a specified number of days on which rainfall was experienced (N) using the following methodology.

1. Determine all parameters and/or indices involved in the stochastic yield model. These parameter values may be determined by existing data, literature search, and calibrating the model with existing yield data. Exemplary possible parameters comprise and/or may correspond to a soil moisture-dependent grain-filling rate, the sensitivity of crop yield to drought, the soil moisture level, and/or the like.

2. Generate a large ensemble of rainfall realizations and/or possible rainfall indices. For each realization, do the followings:
Determine N rainfall depths by drawing N values from a probability distribution e.g. an exponential probability distribution. For example, the probability distribution may correspond to the rainfall distribution at the location of the crop and/or nearby the location of the crop during the growing season of the crop, and/or the like. At the end of this step, there will be N values of rainfall depths: R′ᵢ with i=1, 2, . . . , N.
Sum up all N rainfall depths, Σᵢ₌₁^{N} R′ᵢ
Then, multiply each R′ᵢ with the factor

$$\frac{TR}{{\sum }_{i = 1}^{N} {R}_{i}^{′}} .$$

Denote each new value with Rᵢ.
At this point, there are N of Rᵢ values with Σᵢ₌₁^{N} Rᵢ=TR—that is, N rainfall depths for the specified number of rainy days N that add up to the specified total rainfall TR.

3. Implement these rain depths in a numerical simulation.
Pick a small time step dt, e.g., 0.1 day, 0.5 day, 1 day.
Break down the duration of crop development T into T/dt intervals. In one example embodiment, T is the duration that is agreed upon for determining the specified total rainfall (TR) and number of rainy days (N). In one example embodiment, T is different from the duration for determining the specified total rainfall (TR) and number of rainy days (N).
Randomly select N out of the T/dt intervals and assign Rᵢ to each of them.

4. Use this rainfall signal to drive a crop yield model. For example, the rainfall signal may be used to drive the crop yield model described in more detail in Appendix B of the corresponding provisional application (U.S. Appl. No. 62/402,128, filed Sep. 30, 2016). At the end of the duration of crop development T, record the final yield level Y.

5. Repeat steps 2 thru 4 for a large number of times, say, m. In various embodiments, m may be 10, 100, 250, 1000, 3500, 10000, and/or the like. Therefore, there will be m values of Yᵢ, i=1, 2, . . . m.

6. Construct the probability distribution of yield based on these m values of yields. This probability distribution of yield is the yield distribution associated with a specified total rainfall and a specified number of rainy days and may be used to determine the yield level with a given risk level, in an example embodiment. For example, it may be predicted that there is a 60% chance that given the total rainfall TR and N rainy days, the yield would fall below the 60^{th} percentile of the yield distribution constructed from this procedure—let us use, say, Y₆₀ to denote this yield level. Such yield estimates at a specified residual risk level or yield estimates associated with other risk measures can be combined with a crop price model and/or actual or predicted crop unit value to determine a crop value estimate and/or crop indicator. For example, a yield distribution may be generated as described above for each of a plurality of values of total rainfall and rainy days to determine, generate, and/or the like a crop indicator and/or a crop indicator array indexed by the corresponding rainfall indices.

Continuing with FIG. 4, at block 410, a crop value estimate may be determined. For example, the analysis computing entity 10 may determine a crop value estimate. In example embodiments, the crop value estimate may be an expected crop value, mean crop value, a crop value at risk, a crop value at a specified residual risk, a crop value at a specified risk measure determined based on the crop yield estimate and one or more unit prices for the crop. In an example embodiment, an average unit price may be used to determine the crop value estimate, wherein the average unit price is an average or weighted average of two or more unit prices determined by different methods. For example, a predicted price per unit of the crop may be determined and/or received (e.g., from the index information/data computing entity 40 and/or the like) and used to determine a crop value estimate based at least in part on the crop yield estimate. For example, the crop value estimate and/or unit price for the crop may be determined based on one or more financial instruments, derivatives, and/or the like corresponding and/or related to the crop; global, country, regional, or local crop yield models; one or more supply and demand models; one or more financial models, and/or the like. In an example embodiment, the crop value estimate may be determined based on a location of the crop.

At block 412, a crop indicator may be determined. For example, the analysis computing entity 10 may determine a crop indicator corresponding to a state or states of the crop. For example, the crop indicator may be determined based at least in part on the crop value estimate, location of the crop, and/or the like. For example, the crop indicator may indicate and/or correspond to a predicted and/or current and/or previous state (e.g., if the crop has already been harvested) of the crop. For example, the crop indicator may indicate that the crop has produced well (and/or is predicted to do or to have done or is doing well under the weather conditions indicated by the measurement information/data), the crop has produced moderately well (and/or is predicted to do or to have done or is doing moderately well under the weather conditions indicated by the measurement information/data), the crop has produced poorly (and/or is predicted to do or to have done or is doing poorly under the weather conditions indicated by the measurement information/data), and/or the like. For example, the crop indicator may indicate whether it is predicted that the farmer will profit, lose money on, or will break even on the production of the crop.

At block 414, a premium and/or payout for one or more multiple rainfall index insurance policies for insuring the crop may be determined and/or the premium and/or payout for at least one of the multiple rainfall index insurance policies for insuring the crop may be provided. For example, the analysis computing entity 10 may determine a premium and/or payout for one or more multiple rainfall index insurance policies for insuring the crop and/or may provide a communication comprising the premium and/or payout for at least one multiple rainfall index insurance policy for insuring the crop. For example, the premium and/or payout for each of the multiple rainfall index insurance policies may be based at least in part on the crop value estimate, the location of the crop, and/or the like. In various embodiments, the determination of the premium and/or payout for each multiple rainfall index insurance policy may be based on the crop, policies of the insurance policy provider, rules and/or regulations governing insurance policies covering the crop in the location of the crop, particular level of coverage provided by the policy, and/or the like. In example embodiments, the provided communication comprising the premium and/or payout may further comprise additional information/data. For example, the crop yield estimate, crop value estimate, additional index information/data, insurance policy terms and conditions, and/or the like may be provided with the determined premium and/or payout. The at least one provided determined premium and/or payout may be configured for display by, for example, a user computing entity 20 via a web-based portal, a dedicated application operating on the user computing entity 20, and/or the like. In example embodiments, a user computing entity 20 may receive the communication, process the communication, and display at least a portion of the information/data provided by the communication. For example, in response to receiving the communication, the user computing entity 20 may display the premium and/or payout for the at least one multiple rainfall index insurance policy for insuring the crop by a display device thereof. In another example embodiment, the analysis computing entity 10 may display the premium and/or payout for the at least one multiple rainfall index insurance policy by a display device thereof, cause the premium and/or payout for the at least one multiple rainfall index insurance policy to be printed by a printer, provide the premium and/or payout for the at least one multiple rainfall index insurance policy as audible output (e.g., through a speaker or through an automated phone call or voicemail), and/or the like. As noted above, various other determinations may be made based on the determined crop indicator (e.g., insurance policies premiums and/or payouts, a crop dividend, crop planning, and/or the like.

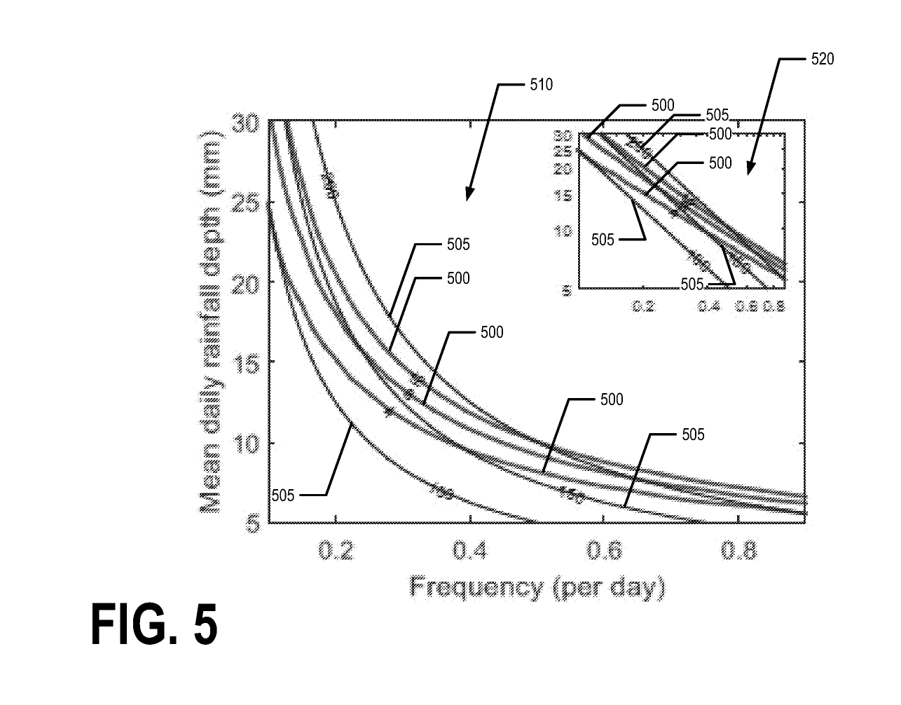

Thus, example embodiments are configured to determine a crop yield estimate, crop value estimate, premium and/or payout for one or more multiple rainfall index insurance policies, and/or the like for a crop based on two or more rainfall indices. Traditionally, rainfall index insurance policies are determined based on a single rainfall index. In particular, rainfall index insurance policies for a crop tend to be based on the total amount of rain received during a particular time period of the growing season of the crop. FIG. 5 provides a plot 510 showing a comparison between contours of (a) a two rainfall index crop yield model 500 based on the indices of average rainfall per day and number of days during which rain was received and (b) a one rainfall index crop yield model 505 based on the single index of total amount of rainfall over the time period. Plot 520 provides a log-log version of the plot 510, highlighting the non-unique relationship between the two rainfall index crop yield model 500 and the one rainfall index crop yield model 505. While requiring minimal measurement information/data (e.g., daily rain gauge measurements), the two rainfall index crop yield model 500 provides a better estimate of crop yield and therefore reduces the basis risk of index insurance.

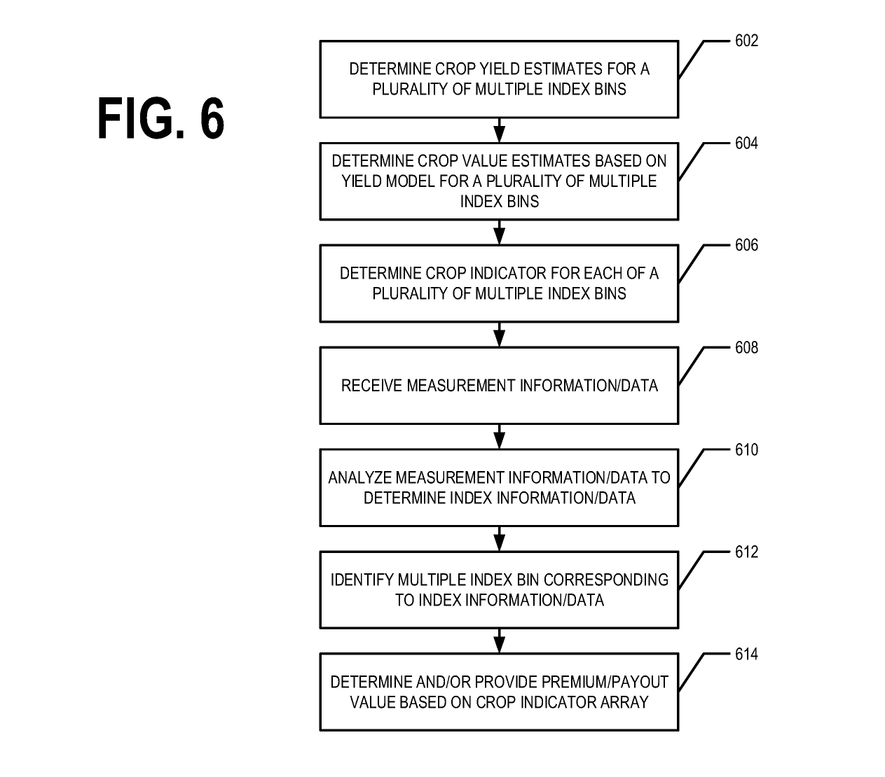

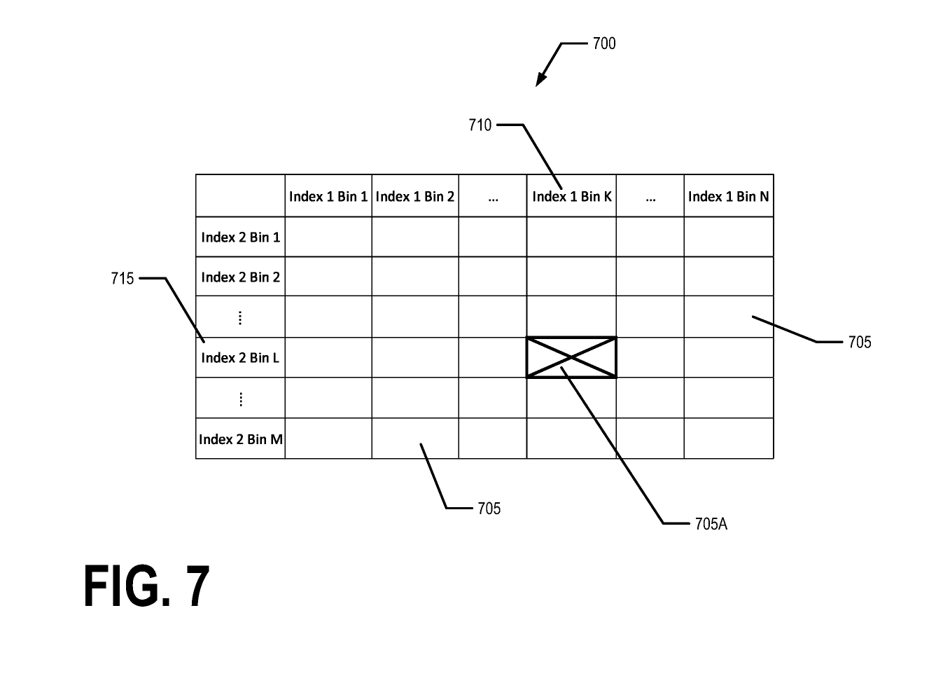

FIG. 6 provides another flowchart illustrating processes and procedures that may be performed in another example embodiment to perform a multiple rainfall index analysis to provide a premium and/or payout value for one or more multiple rainfall index insurance policies for a particular crop. Starting at block 602, a yield estimate for a crop may be determined for a number of index bins. For example, the analysis computing entity 10 may determine a yield estimate for a crop for a plurality of index bins. For example, the two or more indices may be binned into a plurality of bins. In example embodiments, the plurality of index bins are determined at least in part based on two or more rainfall indices. For example, if one of the indices is the number of days rain was received over a thirty day period, the index may be binned into the bins 1-3 days, 4-8 days, 9-12 days, 13-16 days, 16-20 days, 21-30 days, and/or the like. Thus, a plurality of bins for each index of the two or more indices may be identified, determined, defined, and/or the like. In this manner a plurality of multiple index bins may be defined. For example, FIG. 7 shows, for an example embodiment having two indices, a plurality of multiple index bins 705 that are each defined by a bin of a first index 710 and a bin of a second index 715. A crop yield estimate model may be evaluated for at least one of and/or each of the multiple index bins 705. In example embodiments, the crop yield estimate model may be evaluated at a point along a boundary of a bin, a center of the bin, an average over the bin, a point on the interior of the bin, and/or the like as appropriate for the application. In example embodiments, the crop yield model may be based on and/or evaluated based on the crop, location of the crop, the two or more indices, and/or the like.

At block 604, a crop value estimate for one or more multiple index bins 705 may be determined. For example, the analysis computing entity 10 may determine a crop value estimate for at least one and/or each of the multiple index bins 705. For example, a price estimate per unit of the crop may be determined and/or received (e.g., from the index information/data computing entity 40 and/or the like) and used to determine a crop value estimate for a multiple index bin 705 based at least in part on the crop yield estimate of the multiple index bin 705. For example, the crop value estimate may be determined based on one or more financial instruments, financial derivatives and/or the like corresponding and/or related to the crop, global crop yield models or predictions, one or more financial models, and/or the like. In an example embodiment, the crop value estimate may be determined based on a location of the crop.

Returning to FIG. 6, at block 606, a crop indicator array is determined. For example, a crop indicator may be determined for one or more multiple index bins 705. For example, the analysis computing entity 10 may determine a crop indicator for the crop for at least one and/or each of the multiple index bins 705. For example, the crop indicator determined for a particular multiple index bin 705A may indicate and/or correspond to a predicted state of the crop if the rainfall indices correspond to the indices identifying the particular multiple index bin 705A. In another example, the crop indicator determined for a particular multiple index bin 705A may indicate and/or correspond to a predicted state of the crop if the rainfall and other considered weather parameters correspond to the indices identifying the particular multiple index bin 705A. For example, the crop indicator determined for the particular multiple index bin 705A corresponds to a predicted state of the crop at the end if the rainfall and/or other weather parameters experienced during the period of time at the location of the crop (or nearby the location of the crop) corresponding to the indices of the particular multiple index bin 705A. For example, the crop indicator may be determined based at least in part on the crop value estimate, location of the crop, and/or the like for the set of indices corresponding to the particular multiple index bin 705A. For example, the crop indicator may indicate that the crop is predicted to produce well, the crop is predicted to produce moderately well, the crop is predicted to produce poorly, and/or the like under the conditions indicated by the indices corresponding to the particular multiple index bin 705A. For example, the crop indicator may indicate whether it is predicted that the farmer will profit, lose money on, or will break even on the production of the crop under the conditions indicated by the indices corresponding to the particular multiple index bin 705A. Thus, a multiple index look-up table 700, an example of which is shown in FIG. 7, may be populated with crop indicators for one or more multiple rainfall index insurance policies for the crop.

In an example embodiment, a premium and/or payout value for one or more multiple rainfall index insurance policies for the crop may be determined for one or more multiple index bins 705 based on the crop indicator array. For example, the analysis computing entity 10 may determine a premium and/or payout value for one or more multiple rainfall index insurance policies for the crop for at least one and/or each of the multiple index bins 705 based at least in part on the corresponding crop indicator. In various embodiments, the determination of the premium and/or payout for the one or more multiple rainfall index insurance policies may be based on the crop, crop indicator, policies of the insurance policy provider, rules and/or regulations governing insurance policies covering the crop in the location of the crop, level of coverage provided by the insurance policy, and/or the like. Thus, in an example embodiment, an insurance policy multiple index look-up table, similar to the crop indicator multiple index look-up table shown in FIG. 7, may be populated with premiums and/or payouts for one or more multiple rainfall index insurance policies for the crop. In another example, a plurality of insurance policy multiple index look-up tables may be populated with premium and/or payout values for a multiple rainfall index insurance policy providing a particular level of coverage for the crop.

In example embodiments, the processes and procedures of block 602-606 may be completed before, during, and/or after the time period in which the measurement information/data is measured and/or collected. For example, the processes and procedures of block 602-606 may be completed before, after, or during the growing season.

Continuing with FIG. 6, at block 608, measurement information/data relating to a particular crop is received. For example, the one or more sensors 30 may capture measurement information/data. For example, the one or more sensors 30 may be located at the same location and/or in the same geographic area (e.g., within a few miles, in the same town, county, region, state, province, and/or the like) as the particular crop. The one or more sensors 30 may then provide the measurement information/data to one or more analysis computing entities 10, user computing entities 20, and/or index information/data computing entities 40. In another example, the measurement information/data may be displayed to a user by a display in communication with the one or more sensors 30 such that a user may enter the measurement information/data through a user interface of a user computing entity 20. In example embodiments, the measurement information/data may be associated with a sensor location corresponding to the location of the sensor(s) 30 that measured and/or collected the measurement information/data and/or sensor identifier configured to uniquely identify the sensor(s) 30 that measured and/or collected the measurement information/data. In example embodiments, the sensor identifier may be configured such that the sensor location may be determined based on the sensor identifier (e.g., based on a database entry indexed by the sensor identifier and comprising the sensor location, and/or the like). An analysis computing entity 10 may then receive the measurement information/data. For example, the one or more sensors 30, index information/data computing entity 40, and/or user computing entity 20 may provide (e.g., transmit) the measurement information/data such that the analysis computing entity 10 receives the measurement information/data. The measurement information/data received may depend, at least in part, on the crop being considered, the location of the crop, and/or the like. In example embodiments, the measurement information/data may correspond to a particular time period (e.g., a particular portion of the crop preparation, growing season, vegetative period, reproductive period, and/or the like). Crop information/data may also be received as part of a multiple rainfall index insurance policy quote request.

At block 610, the measurement information/data relating to the particular crop is analyzed to determine index information/data relating to the particular crop. For example, the analysis computing entity 10 may analyze the measurement information/data relating to the particular crop to determine index information/data relating to the particular crop. For example, the measurement information/data may comprise a rainfall amount recorded every day over a period of time at the location of the particular crop and/or nearby the location of the particular crop (e.g., within a few miles, in the same town, county, region, state, province, and/or the like). The desired index information/data may comprise the average amount of rainfall per day and the number of days during which rain was received. Therefore, the daily rainfall amount recorded very day over the period of time may be analyzed to determine the average daily rainfall and the number of days during which rain was received for the time period. In example embodiments, the analysis required to determine the index information/data based on the measurement information/data will depend on the available measurement information/data and the desired index information/data, as should be appreciated by one of skill in the art. In example embodiments, the index information/data that is determined is based on the crop, the location of the crop, and/or the like.

At block 612, a multiple index bin 705A of one or more multiple index look-up tables 700 corresponding to the index information/data is identified. For example, the analysis computing entity 10 may identify a multiple index bin 705A corresponding to the index information/data. In example embodiments, identifying the multiple index bin 705A of the multiple index look-up table 700 comprises identifying an appropriate multiple index look-up table for the particular crop based on the crop information/data and then identifying the multiple index bin based on the index information/data. For example, a multiple index look-up table 700 that was determined using a crop yield model that is appropriate for the particular crop (and/or desired insurance coverage level) may be identified. For example, the crop yield model evaluated to determine the multiple index look-up table may be based, selected, optimized, and/or the like at least in part on a crop that is similar to the particular crop. For example, the crop yield model may be determined for the same crop type as the particular crop and for a location that is in the same geographical area as the particular crop. After identifying the appropriate multiple index look-up table 700, or in response thereto, the multiple index bin 705A may be identified based on the index information/data. For example, the index information/data may indicate that the value of the first index falls into Bin K of index one and the value of the second index falls into Bin L of index two. The multiple index look-up table 700 may then be used to identify multiple index bin 705A corresponding to Bin K of index one and Bin L of index two. The crop indicator of the identified multiple index bin 705A corresponds to the predicted and/or estimated current state of the crop based on the indices determined based on the received measurement information/data.

At block 614, the premium and/or payout for at least one of the one or more multiple rainfall index insurance policies for the particular crop may be determined and/or provided. For example, the analysis computing entity 10 may determine a premium and/or payout for at least one of the one or more multiple rainfall index insurance policies and/or provide a communication comprising the premium and/or payout for at least one multiple rainfall index insurance policy for insuring the particular crop. In an example embodiment, the premium and/or payout for one or more multiple rainfall index insurance policies for the particular crop may then be read off of one or more insurance policy multiple index look-up tables at the identified multiple index bin and/or determined based on the crop indicator of the identified multiple index bin 705A. In example embodiments, the provided communication may further comprise additional information/data. For example, the crop yield estimate for the identified multiple index bin 705A, crop value estimate for the identified multiple index bin 705A, additional index information/data, insurance policy terms and conditions, and/or the like may be provided with the at least one premium and/or payout. The provided at least one determined premium and/or payout may be configured for display by, for example, a user computing entity 20 via a web-based portal, a dedicated application operating on the user computing entity 20, and/or the like. In example embodiments, a user computing entity 20 may receive the communication, process the communication, and display at least a portion of the information/data provided by the communication. For example, in response to receiving the communication, the user computing entity 20 may display the premium and/or payout for the at least one multiple rainfall index insurance policy by a display device thereof. In another example embodiment, the analysis computing entity 10 may display the premium and/or payout for the at least one multiple rainfall index insurance policy by a display device thereof, cause the premium and/or payout for the at least one multiple rainfall index insurance policy to be printed by a printer, provide the premium and/or payout for the at least one multiple rainfall index insurance policy as audible output (e.g., through a speaker or through an automated phone call or voicemail), and/or the like.

Various embodiments of the present invention provide technological improvements to the technical field of crop management, automated determination of a crop indicator corresponding to a predicted state and/or states of a crop (and/or multiple crops) and/or a crop indicator array comprising a plurality of crop indicators each corresponding to a set of indices. The crop indicator and/or crop indicator array are determined using a multiple index rainfall analysis. In an example embodiment, a crop indicator or crop indicator array may be used to determine insurance premiums and/or payouts for one or more insurance policies for insuring the crop. For example, various embodiments provide for determination of a crop indicator that is determined based on consideration of two or more rainfall indices, possibly in addition to other indices and/or other weather indices. The consideration of multiple rainfall indices allows for evaluation of a more accurate crop yield model. Additionally, the multiple rainfall indices allows for improved evaluation of the predicted state of the crop. Example embodiments allow for the determination of the multiple indices at a location where the crop is located, for example, through the use of the one or more sensors 30 located at the location and/or near the location of the crop and being able to securely communicate with analysis computing entity 10, a user computing entity 20, an index information/data computing entity 40, and/or the like via one or more networks 50. Thus, various embodiments provide an improvement to assessing the risk and evaluating the predicted state of a crop so as to, for example, accurately determine various parameters of a multiple rainfall index insurance policy, prevent fraud related to a damage-based agricultural insurance policy, and reduce the basis risk experienced by a user. In particular, the use of the two or more rainfall indices in determining a crop indicator with or without one or more aspects of a weather index insurance policy for insuring the crop provides an improvement over traditional weather index insurance policies by providing an improved modeling of the state of the crop and reducing basis risk.

### IV. CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1-20. (canceled)

21. A method for determining a crop indicator corresponding to at least one state of at least one crop, the method comprising:
receiving, by an analysis computing entity comprising at least one processor and a communications interface configured for communicating via at least one network, measurement data captured by one or more sensors at a location at least nearby the crop, at least one of the one or more sensors configured to capture measurement data
corresponding to rainfall;
analyzing, by the analysis computing entity, the measurement data to determine index data, wherein the index data comprises index data relating to two or more rainfall indices;
determining, by the analysis computing entity, a crop yield estimate based on the index data and an appropriate crop yield model;
determining, by the analysis computing entity, a crop value estimate based on the crop yield estimate; and
determining, by the analysis computing entity, the crop indicator based on the crop value estimate.

22. The method of claim 21, further comprising determining a premium and/or payout for a multiple rainfall index insurance policy based on the crop indicator.

23. The method of claim 22, wherein the multiple rainfall index insurance policy is based on at least two indices.

24. The method of claim 23, wherein the at least two indices comprise average daily rainfall for a time period and number of days in the time period wherein rainfall was experienced.

25. The method of claim 22, wherein the premium and/or payout is based at least in part on the corresponding location.

26. The method of claim 22, wherein the premium and/or payout are provided for display to a user through an output device of a user computing entity.

27. The method of claim 22, wherein the premium and/or payout is determined based on a desired coverage level.

28. The method of claim 21, wherein the measurement data comprises a daily rainfall amount for one or more days.

29. The method of claim 21, wherein the measurement data is associated with a corresponding location, the corresponding location being a physical location of a sensor that collected the measurement data during the collection of the measurement data, the corresponding location being at a location of the crop or in a same geographic area as the location of the crop.

30. The method of claim 29, wherein the crop yield estimate is based on a location-dependent model and the crop yield estimate is determined based at least in part on the corresponding location.

31. The method of claim 29, wherein the crop value estimate is based on a location-dependent model and the crop value estimate is determined based at least in part on the corresponding location.

32. The method of claim 21, wherein the measurement data is received through a sensor control unit.

33. The method of claim 21, wherein the measurement data is received through a user providing the measurement data through a user interface of a user computing entity.

34. The method of claim 21, wherein the two or more indices comprise two rainfall indices and one or more additional indices.

35. The method of claim 34, wherein the one or more additional indices comprise at least one weather related index.

36. The method of claim 35, wherein the at least one weather related index comprises at least one temperature index.

37. The method of claim 21, wherein the crop yield model is at least one of a stochastic model or a numerical simulation.

38. A method for determining a crop indicator corresponding to at least one state of at least one crop, the method comprising:
determining, by an analysis computing entity comprising at least one processor and a communications interface configured for communicating via at least one network, a crop yield estimate for each of a plurality of bins based on a multiple index crop yield model, each bin characterized by two or more indices, wherein the two or more indices comprise two or more rainfall indices;
determining, by the analysis computing entity, a crop value estimate for at least one bin of the plurality of bins based on the crop yield estimate of the bin;
determining, by the analysis computing entity, a crop indicator array, the crop indicator array comprising a particular crop indicator for a particular bin of the plurality of bins determined based on the crop value estimate of the particular bin;
receiving, by the analysis computing entity, measurement data related to the crop, measurement data captured by one or more sensors at a location at least nearby the crop, at least one of the one or more sensors configured to capture measurement data
corresponding to rainfall;
analyzing, by the analysis computing entity, the measurement data to determine index data;
identifying, by the analysis computing entity, a particular bin of the plurality of bins based on the index data; and
determining, by the analysis computing entity, the crop indicator based on the identified particular bin.

39. An apparatus for determining a crop indicator corresponding to at least one state of at least one crop comprising at least one processor, a communications interface configured for communicating via at least one network, and at least one memory storing computer program code, the at least one memory and the computer program code configured to, with the processor, cause the apparatus to at least:
receive measurement data related to the crop, the measurement data captured by one or more sensors at a location at least nearby the crop, at least one of the one or more sensors configured to capture measurement data corresponding to rainfall;
analyze the measurement data to determine index data, wherein the index data comprises index data relating to two or more rainfall indices;
determine a crop yield estimate based on the index data and an appropriate crop yield model;
determine a crop value estimate based on the crop yield estimate; and
determine the crop indicator based on at least one of the crop value estimate or the crop yield estimate.

40. The apparatus of claim 39, wherein the at least one memory and the computer program code are further configured to, with the processor, cause the apparatus to at least determine a premium and/or payout for a multiple rainfall index insurance policy based on (a) the crop indicator, (b) at least two indices, and (c) the corresponding location.
